(19) United States
(12) Patent Application Publication
(10) Pub. No.: US 2018/0284739 A1
(43) Pub. Date: Oct. 4, 2018

(54) QUALITY CONTROL APPARATUS, QUALITY CONTROL METHOD, AND QUALITY CONTROL PROGRAM

(71) Applicant: MITSUBISHI ELECTRIC CORPORATION, Tokyo (JP)

(72) Inventors: Takafumi UEDA, Tokyo (JP); Makoto IMAMURA, Tokyo (JP); Takaaki NAKAMURA, Tokyo (JP); Norio HIRAI, Tokyo (JP)

(73) Assignee: MITSUBISHI ELECTRIC CORPORATION, Tokyo (JP)

(21) Appl. No.: 15/759,156

(22) PCT Filed: Mar. 28, 2016
(86) PCT No.: PCT/JP2016/059885

§ 371 Date: Mar. 9, 2018

(51) Int. Cl. G05B 19/418; G06T 7/00; G06F 17/18

(52) U.S. Cl. CPC G05B 19/41875; G06F 17/18; G06T 7/0004; G05B 19/4183

(57) ABSTRACT

A quality control apparatus (20) includes: a regression analyzer (33) for calculating a regression formula on the basis of measurement values acquired from an upstream step and comparative measurement values acquired from a downstream step; a margin determination unit (34) for calculating a prediction value by substituting a determination reference value defining a determination reference range in the upstream step for an explanatory variable of the regression formula, comparing the prediction value with a comparative determination reference range in a downstream step, and determining whether the measurement values are accepted; and a reference value calculator (35) for calculating a new determination reference value to replace the determination reference value in accordance with the determination result.

### TECHNICAL FIELD

The present invention relates to a quality control technique in a manufacturing process including a plurality of steps and particularly to a quality control technique used in an inspection step forming a part of the manufacturing process.

### BACKGROUND ART

In many cases, in factories, products are manufactured by a manufacturing process that includes a plurality of steps. In such a manufacturing process, various types of operations (for example, assembling of parts or processing of parts in each step) are sequentially executed from a step in an upstream stage to another step in a downstream stage. Moreover, in such a manufacturing process, an inspection step can be included in order to determine whether the quality of an intermediate product or a product (i.e., a final product) is good. In an inspection step, for example a measurement value indicating the state of an intermediate product or product (for example, dimensions such as a thickness or an electrical characteristic value) is measured using a measuring instrument such as a sensor. If the measurement value satisfies a determination reference that is prescribed, it is determined that the quality is nondefective. If the measurement value does not satisfy the determination reference, it is determined that the quality is defective. A product whose quality is determined to be defective (hereinafter also referred to as “defective product”) is temporarily removed from the manufacturing line, and subjected to adjustment such as correction. Thereafter, entry of the product into the manufacturing line is performed again, or the product is discarded. The determination reference can be set, for example, by a designer or an administrator of the manufacturing process on the basis of his own past experience or design knowledge.

On the other hand, as disclosed in Patent Literature 1 (Japanese Patent Application Publication No. 2009-99960), a method of determining whether quality is good or not by a statistical method called multiple regression analysis. In the method of Patent Literature 1, a multiple regression formula is developed by executing the multiple regression analysis that uses, as the explanatory variable, measurement values acquired in a plurality of steps (including a processing step and an inspection step) forming a manufacturing process, and that uses electrical characteristic values of a product as the objective variable. Once the multiple regression formula is developed, a prediction value as an electrical characteristic value of the product is calculated by assigning measurement values to the explanatory variable of the multiple regression formula. The occurrence of a quality deficiency can be predicted when the prediction value deviates from a control range.

### CITATION LIST

### Patent Literature

Patent Literature 1: Japanese Patent Application Publication No. 2009-99960.

### SUMMARY OF INVENTION

### Technical Problem

In a case where an inspection step is provided in an upstream stage of a manufacturing process, when the determination reference for the inspection step is excessively loose, rework due to an increase in the number of defective products in a downstream step frequently occurs, possibly resulting in a decrease in its yield. Conversely, when the determination reference for the inspection step in the upstream stage is excessively tight, the number of defective products increases due to the requirement of excessively high quality in the inspection step in the upstream stage, possibly resulting in a decrease in its yield. In the method of Patent Literature 1, it is difficult to flexibly change a determination reference for an inspection step in an upstream stage, depending on the condition of a downstream step. Therefore, a decrease in its yield may possibly occur due to an excessively tight or excessively loose determination reference in the inspection step.

In view of the above, it is an object of the present invention to provide a quality control apparatus, quality control method and quality control program which are capable of flexibly setting a determination reference for an upstream step depending on the condition of a downstream step.

### Solution to Problem

According to one aspect of the present invention, there is provided a quality control device which includes: a measurement value receiver configured to acquire a series of measurement values from an upstream step which is one of an inspection step and a fabrication step among a plurality of steps forming a manufacturing process, and configured to acquire a series of comparative measurement values corresponding to the series of the measurement values, from a downstream step which is another inspection step among the plurality of steps in downstream stages with respect to the upstream step; a regression analyzer configured to execute a regression analysis using the measurement values as values of an explanatory variable and using the comparative measurement values as values of an objective variable, thereby to calculate a regression formula; a margin determination unit configured to calculate a prediction value by assigning a determination reference value defining a determination reference range for quality determination in the upstream step, to the explanatory variable of the regression formula, and configured to compare the prediction value with a comparative determination reference range for quality determination in the downstream step to determine whether the measurement values are accepted; and a reference value calculator configured to calculate a new determination reference value for replacement of the determination reference value in accordance with the determination result of the margin determination unit.

According to another aspect of the present invention, there is provided a quality control method to be executed in a quality control apparatus for controlling quality in a plurality of steps forming a manufacturing process. The quality control method includes: acquiring a series of measurement values from an upstream step which is one of an inspection step and a fabrication step among a plurality of steps forming a manufacturing process; acquiring a series of comparative measurement values corresponding to the series of the measurement values, from a downstream step which is another inspection step among the plurality of steps in downstream stages with respect to the upstream step; executing a regression analysis using the measurement values as values of an explanatory variable and using the comparative measurement values as values of an objective variable thereby to calculate a regression formula; calculating a prediction value by assigning a determination reference value defining a determination reference range for quality determination in the upstream step, to the explanatory variable of the regression formula; comparing the prediction value with a comparative determination reference range for quality determination in the downstream step to determine whether the measurement values are accepted; and calculating a new determination reference value for replacement of the determination reference value in accordance with the determination result.

According to still another aspect of the present invention, there is provided a quality control program for controlling quality in a plurality of steps forming a manufacturing process. The quality control program which causes a computer to execute the operations of: acquiring a series of measurement values from a upstream step which is one of an inspection step and a fabrication step among a plurality of steps forming a manufacturing process; acquiring a series of comparative measurement values corresponding to the series of the measurement values from a downstream step which is another inspection step among the plurality of steps in downstream stages with respect to the upstream step; executing a regression analysis using the measurement values as values of an explanatory variable and using the comparative measurement values as values of an objective variable thereby to calculate a regression formula; calculating a prediction value by assigning a determination reference value defining a determination reference range for quality determination in the upstream step, to the explanatory variable of the regression formula; comparing the prediction value with a comparative determination reference range for quality determination in the downstream step to determine whether the measurement values are accepted; and calculating a new determination reference value for replacement of the determination reference value in accordance with the determination result.

### Advantageous Effects of Invention

According to the present invention, a determination reference range in an upstream step in an upstream stage can be set depending on the condition of a downstream step, thereby making it possible to improve its yield.

### BRIEF DESCRIPTION OF DRAWINGS

FIG. 1 is a diagram schematically illustrating an exemplary manufacturing system according to a first embodiment of the present invention.

FIG. 2 is a block diagram illustrating a schematic configuration of a quality control apparatus according to the first embodiment.

FIG. 3 is a diagram illustrating an exemplary format of measurement data stored in a measurement value recording unit according to the first embodiment.

FIG. 4 is a diagram illustrating an exemplary format of step order data stored in a process memory according to the first embodiment.

FIG. 5 is a diagram illustrating an exemplary format of determination reference data stored in a reference value recording unit according to the first embodiment.

FIG. 6 is a diagram illustrating another exemplary format of determination reference data stored in the reference value recording unit according to the first embodiment.

FIG. 7 is a flowchart illustrating an exemplary procedure of tight reference calculating processing according to the first embodiment.

FIG. 8 is a graph illustrating an exemplary regression formula.

FIGS. 9A and 9B are graphs illustrating exemplary change of a determination reference range.

FIG. 10 is a flowchart illustrating an exemplary procedure of loose reference calculating processing according to the first embodiment.

FIG. 11 is a block diagram illustrating an exemplary hardware configuration of the quality control apparatus according to the first embodiment.

FIG. 12 is a block diagram illustrating another exemplary hardware configuration of the quality control apparatus according to the first embodiment.

FIG. 13 is a block diagram illustrating a schematic configuration of a quality control apparatus in a manufacturing system according to a second embodiment of the present invention.

FIG. 14 is a flowchart schematically illustrating an exemplary procedure of process monitoring processing according to the second embodiment.

FIGS. 15A to 15C are diagrams illustrating exemplary image information generated when a tight reference value is newly calculated for a certain measurement item in an upstream step.

FIGS. 16A to 16C are diagrams illustrating exemplary image information generated when a loose reference value is newly calculated for a certain measurement item in an upstream step.

### DESCRIPTION OF EMBODIMENTS

Hereinafter, embodiments of the present invention will be described in detail with reference to the drawings. Components denoted by the same symbol throughout the drawings have the same configuration and the same function.

### First Embodiment

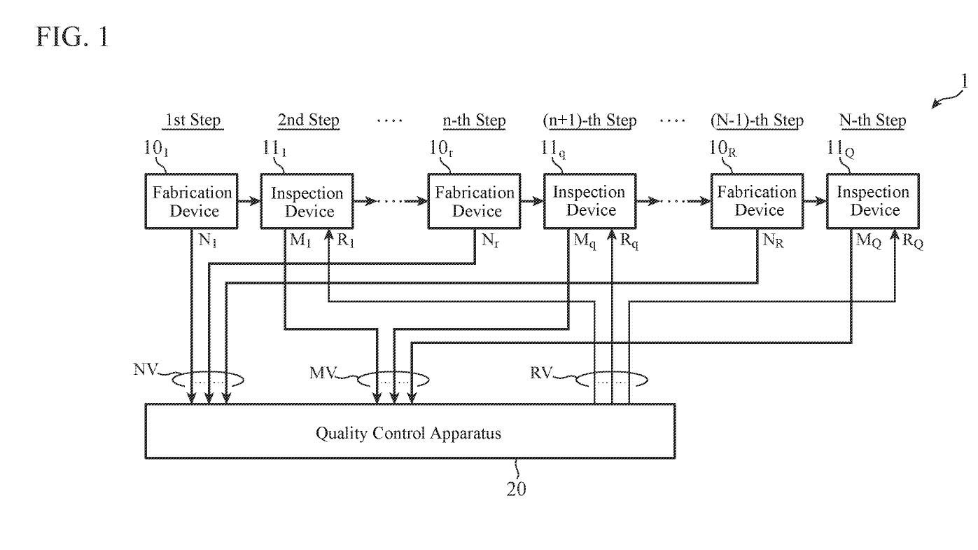

FIG. 1 is a block diagram schematically illustrating an exemplary configuration of a manufacturing system 1 according to a first embodiment of the present invention. As illustrated in FIG. 1, the manufacturing system 1 includes R fabrication devices 10₁, . . . , 10ᵣ, . . . , 10_{R} and Q inspection devices 11₁, . . . , 11_{q}, . . . , 11_{Q} for sequentially executing N steps (where N is a positive integer) from a first step to an N-th step forming a manufacturing process. Here, R and Q are integers of 3 or more. The fabrication devices 10₁ to 10_{R} are a group of devices each of which executes a fabrication step and supplies measurement data N₁ to N_{R}, respectively, representing the state of the fabrication step. The inspection devices 11₁ to 11_{Q} are a group of devices each of which executes an inspection step and supplies measurement data M₁ to M_{Q}, respectively, acquired in the inspection step.

In the configuration example of FIG. 1, the first step is executed by the fabrication device 10₁, the second step is executed by the inspection device 11₁, the n-th step is executed by the fabrication device 10ᵣ, the (n+1)-th step is executed by the inspection device 11_{q}, the (N−1)-th step is executed by the fabrication device 10_{R}, and the N-th step is executed by the inspection device 11_{Q}. Note that the present invention is not limited to such correspondence relationship among the first step to the N-th step, the fabrication devices 10₁ to 10_{R}, and the inspection devices 11₁ to 11_{Q}. Moreover, in the present embodiment, the fabrication devices 10₁ to 10_{R} and the inspection devices 11₁ to 11_{Q} are arranged to be separated from each other, but no limitation thereto intended. The inspection devices may be incorporated in the fabrication devices.

Each of the fabrication devices 10ᵣ (where r is any integer from 1 to R) is capable of measuring one or more types of measurement values that define a process condition and one or more types of measurement values indicating the operation state of each of the fabrication devices by using a measuring instrument such as sensor and supplying measurement data Nᵣ including these measurement values to a quality control apparatus 20. Hereinafter, a type of measurement value is referred to as a “measurement item”. Examples of measurement items for defining a process condition include the substrate temperature, the flow rate of reaction gas, or the pressure inside a chamber in the case of semiconductor manufacturing technology, and the press pressure in the case of press processing technology. Examples of measurement items indicating the operation state of each of the fabrication devices include power consumption of each of the fabrication devices.

Meanwhile, each of the inspection devices 11_{q} (where q is any integer from 1 to Q) is capable of measuring a measurement value of one or more measurement items indicating the state of a fabricated piece (i.e., an intermediate product or final product) by using a measuring instrument such as a sensor and supplying measurement data M_{q} including the measurement value to the quality control apparatus 20. Examples of measurement items indicating the state of a fabricated piece include a dimension such as the thickness of the fabricated piece, the temperature, or an electric characteristic value such as an electric resistance. Hereinafter, a measurement item that can be acquired by the inspection devices 11₁ to 11_{Q} is also referred to as an “inspection item”.

Each of the inspection devices 11_{q} has a function of determining whether the quality of a fabricated piece is within a determination reference (good) or deviates from the determination reference (defective) with respect to an inspection item for which a determination reference range is set. That is, if a measurement value of an inspection item is within the determination reference range, the fabricated piece is determined to be a nondefective piece satisfying the determination reference for the inspection item. On the other hand, if a measurement value of the inspection item is outside the determination reference range, the fabricated piece is determined to be a defective piece that does not satisfy the determination reference for the inspection item. In the present embodiment, one determination reference range is set when one of a combination of an upper limit reference value and a lower limit reference value, only an upper limit reference value, and only a lower limit reference value is given. For example, in a case where the inspection device 11₁ can measure measurement values of two inspection items of “thickness” and “electrical resistance” of an intermediate product, at least one of a determination reference range for quality inspection of “thickness” and a determination reference range for quality inspection of “electrical resistance” can be set. For each inspection item, the inspection device 11_{q} can supply the measurement data M_{q} that includes both a measurement value and a determination result indicating the quality of a fabricated piece, to the quality control apparatus 20. A data structure of the measurement data M_{q} will be described later.

As illustrated in FIG. 1, the manufacturing system 1 further includes the quality control apparatus 20. The quality control apparatus 20 acquires a data group MV including measurement data M₁ to M_{Q} transmitted from the inspection devices 11₁ to 11_{Q} and acquires data group NV including measurement data N₁ to N_{R} transmitted from the fabrication devices 10₁ to 10_{R}. The quality control apparatus 20 is capable of further transmitting data group RV including determination reference data R₁ to R_{Q} for setting a determination reference range to the inspection devices 11₁ to 11_{Q}, respectively. The determination reference data R₁ to R_{Q} is supplied to the inspection devices 11₁ to 11_{Q}, respectively. The inspection devices 11₁ to 11_{Q} are capable of setting its own determination reference range using the determination reference data R₁ to R_{Q}, respectively.

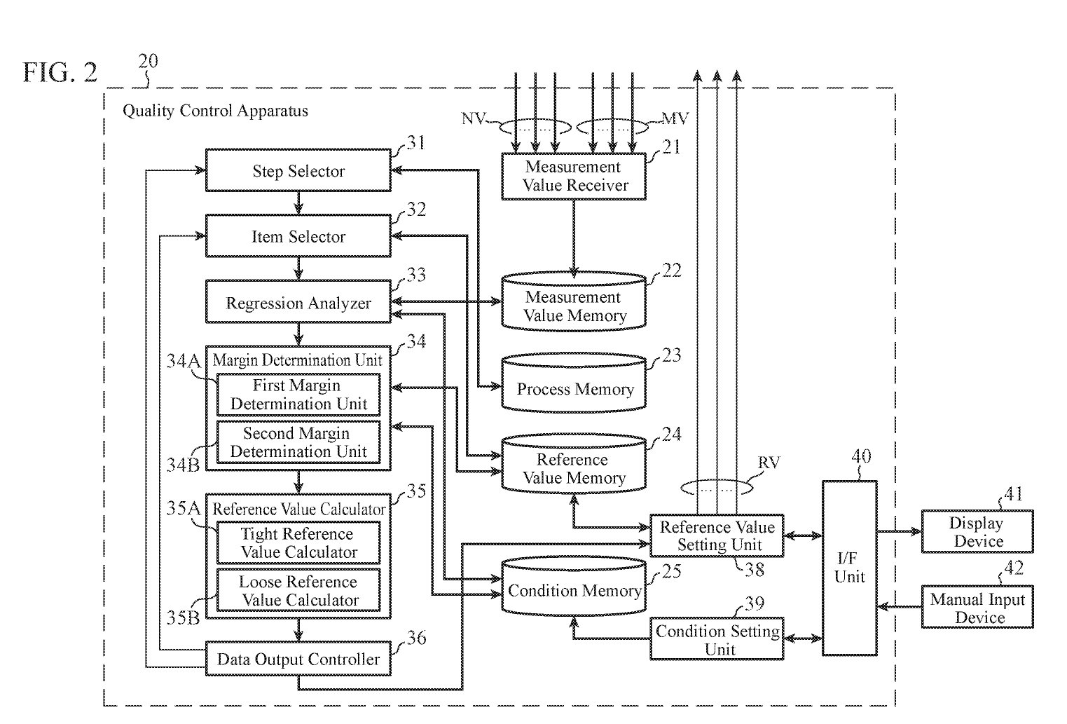

Next, a configuration of the quality control apparatus 20 of the present embodiment will be described. FIG. 2 is a block diagram illustrating a schematic configuration of the quality control apparatus 20 according to the first embodiment. As illustrated in FIG. 2, the quality control apparatus 20 includes a measurement value receiver 21, a measurement value memory 22, a process memory 23, a reference value memory 24, a condition memory 25, a step selector 31, an item selector 32, a regression analyzer 33, a margin determination unit 34, a reference value calculator 35, a data output controller 36, a reference value setting unit 38, a condition setting unit 39, and an interface unit (I/F unit) 40.

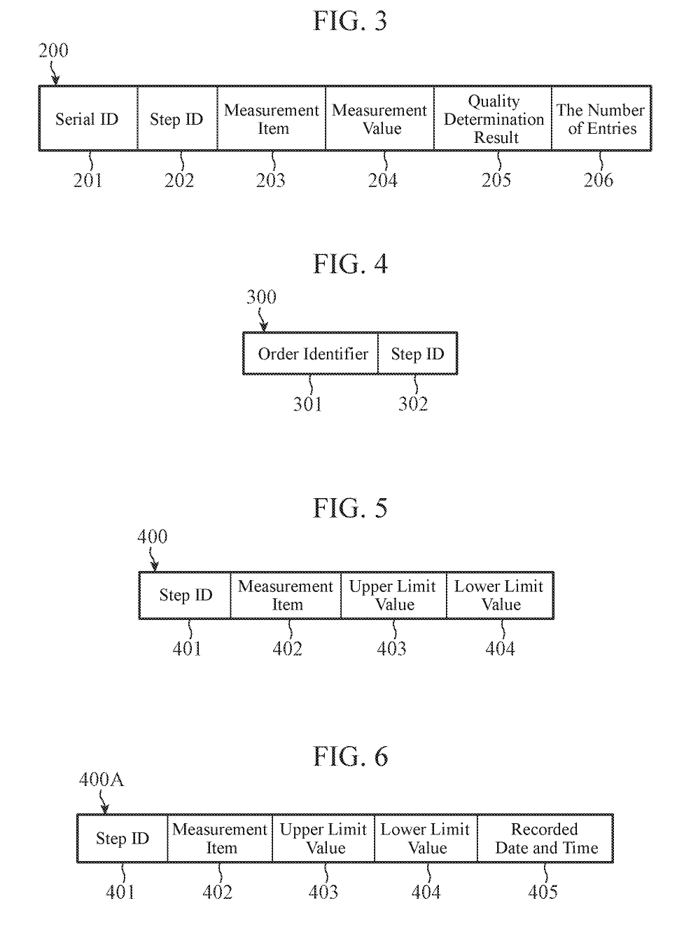

The measurement value receiver 21 acquires the measurement data N₁ to N_{R} and M₁ to M_{Q} from the fabrication devices 10₁ to 10_{R} and the inspection devices 11₁ to 11_{Q} and accumulates the measurement data N₁ to N_{R} and N₁ to M_{Q} in the measurement value memory 22. FIG. 3 is a diagram illustrating an example of a data structure 200 of the measurement data N₁ to N_{R} and M₁ to M_{Q} stored in the measurement value memory 22. The data structure 200 illustrated in FIG. 3 has a data storing area 201 for storing a serial ID which is an identification code for identifying each fabricated piece, a data storing area 202 for storing a step ID which is an identification code for identifying an inspection step, a data storing area 203 for storing identification information of a measurement item, a data storing area 204 for storing a measurement value, a data storing area 205 for storing a quality determination result, and a data storing area 206 for storing the number of entries of the fabricated piece into an inspection step. In this regard, since the fabrication devices 10₁ to 10_{R} do not have the function of performing quality determination on a fabricated piece, the quality determination result is not stored in the data storing area 205 of the measurement data N₁ to N_{R}.

Each fabricated piece that is determined to be a defective piece in an inspection step may be subject to entry into a manufacturing line again after its adjustment, and thus the same piece may be inspected more than once in the same inspection step. Therefore, the number of times the same piece has undergone inspection in a certain inspection step is stored in the data storing area 206 as “the number of entries”. The number of entries can be a serial number starting with 1. In this regard, the lot number of the fabricated piece, the date and time of inspection, or other information may be stored in the measurement value memory 22.

Moreover, the process memory 23 stores step order data indicating an order relation of the plurality of steps forming the manufacturing process. FIG. 4 is a diagram illustrating an example of a data structure 300 of the step order data. The data structure 300 illustrated in FIG. 4 has a data storing area 301 for storing a value of an order identifier indicating the order of the step and a data storing area 302 for storing a step ID. The step ID of FIG. 4 is an identifier code of the same type as that of the step ID illustrated in FIG. 3. For example, it is sufficient that a value of an order identifier assigned to a certain step is always larger than a value of an order identifier assigned to a step in a downstream stage with respect to the certain step. In this regard, the data structure 300 illustrated in FIG. 4 is the simplest example in which there is no merging of a plurality of manufacturing lines nor branching to a plurality of manufacturing lines. The data structure 300 may be modified to enable management of merging and branching of manufacturing lines.

Moreover, the reference value memory 24 stores determination reference data for setting an upper limit reference value (hereinafter also referred to as an “upper limit value”) and a lower limit reference value (hereinafter also referred to as a “lower limit value”) defining a determination reference range in each of the steps. FIG. 5 is a diagram illustrating an example of a data structure 400 of the determination reference data stored in the reference value memory 24. The data structure 400 illustrated in FIG. 5 includes a data storing area 401 for storing a step ID, a data storing area 402 for storing an identification code for identifying a measurement item, a data storing area 403 for storing an upper limit value of a determination reference range, and a data storing area 404 for storing a lower limit value of the determination reference range.

Since the determination reference range may be changed during operation of the manufacturing process, the data structure 400 may be modified to store a recorded date and time indicating when an upper limit value and lower limit value of the determination reference range are set or to store a flag discriminating whether or not the upper limit value and the lower limit value are the latest version. FIG. 6 is a diagram illustrating an example of a data structure 400A in which a data storing area 405 for storing a the recorded date and time is added to the data structure 400 illustrated in FIG. 5.

The condition memory 25 stores condition values such as a threshold value for correlation determination to be compared with an absolute value of a correlation coefficient to be described later and a threshold value for margin determination.

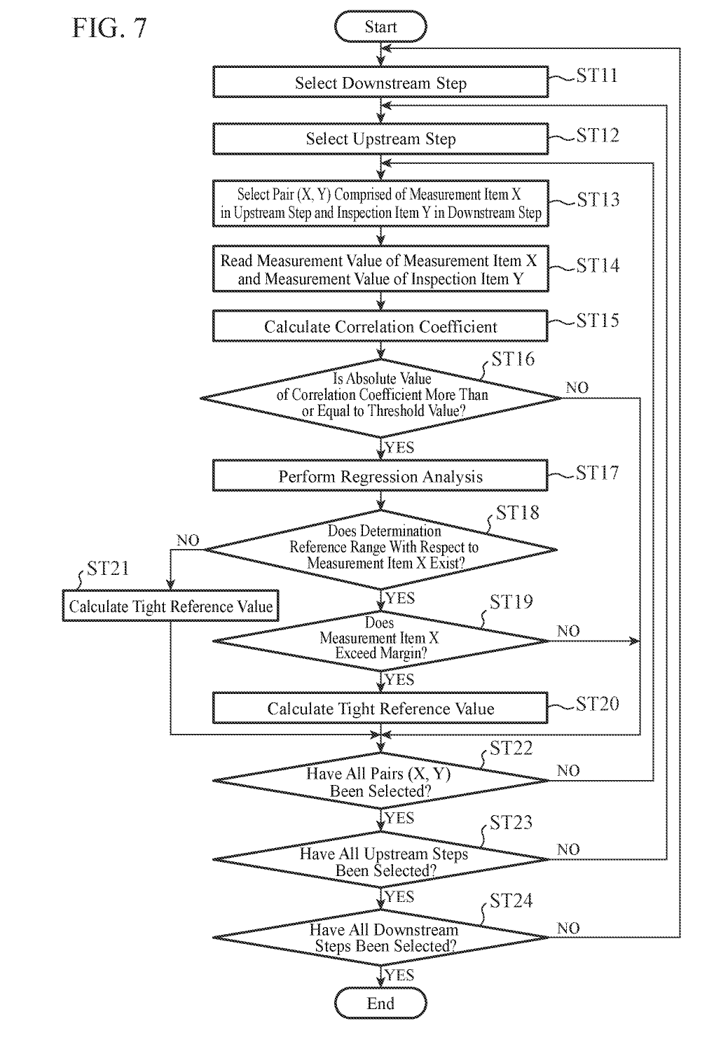

Next, with reference to FIGS. 7 to 10, operations of the step selector 31, the item selector 32, the regression analyzer 33, the margin determination unit 34, the reference value calculator 35, and the data output controller 36 of the quality control apparatus 20 will be described. FIG. 7 is a flowchart schematically illustrating an exemplary procedure of tight reference calculating processing according to the first embodiment.

Referring to FIG. 7, first, the step selector 31 refers to the step order data (FIG. 4) stored in the process memory 23 and selects one inspection step forming the manufacturing process as a downstream step to be analyzed (step ST11). On the basis of a combination of an order identifier and a step ID in the step order data, the step selector 31 can select, for example, an inspection step in a downstream stage with respect to the first inspection step, as the downstream step. Then, the step selector 31 refers to the step order data stored in the process memory 23 and selects one of an inspection step and a fabrication step in upstream stages with respect to the downstream step selected in step ST11, as an upstream step (step ST12).

Next, the item selector 32 refers to the determination reference data (FIG. 5) stored in the reference value memory 24 and selects a pair (X, Y) of a measurement item X in the selected upstream step and an inspection item Y of one measurement item in the selected downstream step (step ST13). Here, if it is clear that no quality defect occurs in the selected inspection item in the downstream step, the item selector 32 is not required to select the inspection item.

Next, the regression analyzer 33 reads a series of measurement values of the measurement item X and a series of measurement values of the inspection item Y from the measurement value memory 22 (step ST14). More specifically, in a case where a serial ID of each fabricated piece is denoted by an integer i, a measurement value of the measurement item X is denoted by x_{α}(i), and a measurement value of the inspection item Y is denoted by y_{β}(i), the regression analyzer 33 reads a series of measurement values x_{α}(1), x_{α}(2), x_{α}(3), . . . of the measurement item X and a series of measurement values y_{β}(1), y_{β}(2), y_{β}(3), . . . of the measurement item Y from the measurement value memory 22 (step ST14), where α and β are identification codes of the measurement items X and Y, respectively.

In a case where a plurality of measurement values exist for one measurement item in one step with respect to each fabricated piece, the regression analyzer 33 is only required to select and read the latest measurement value which has been determined to have a good quality from among the plurality of measurement values for the measurement item X in the upstream step. As for the inspection item Y in the downstream step, the regression analyzer 33 may select and read a measurement value at the time of the first entry into the manufacturing line (when the number of entries is “1”) from among such a plurality of measurement values.

After step ST14, the regression analyzer 33 calculates a correlation coefficient c₁ between the series of measurement values of the measurement item X and the series of measurement values of the inspection item Y (step ST15). The correlation coefficient c₁ can be calculated using, for example, a known cross-correlation function. Then, the regression analyzer 33 acquires a threshold value TH₁ for correlation determination from the condition memory 25 and determines whether an absolute value of the correlation coefficient c₁ is larger than or equal to the threshold value TH₁ (step ST16). If it is determined that the absolute value of the correlation coefficient c₁ is not larger than or equal to the threshold value TH₁ (NO in step ST16), the regression analyzer 33 shifts the processing to step ST22. In this regard, a statistical index other than the correlation coefficient may be used as long as the statistical index is a numerical value representing the degree of correlation between the series of measurement values of the measurement item X and the series of measurement values of the inspection item Y.

On the other hand, if it is determined that the absolute value of the correlation coefficient c₁ is larger than or equal to the threshold value TH₁ (YES in step ST16), the regression analyzer 33 determines that the degree of correlation between the series of measurement values of the measurement item X and the series of measurement values of the inspection item Y is high and executes regression analysis using the measurement values x_{α}(i) of the measurement item X as values of the explanatory variable and using the measurement values y_{β}(i) of the inspection item Y as values of the objective variable, thereby to calculate a regression formula (step ST17).

Thereafter, on the basis of the determination reference data of the upstream step, the regression analyzer 33 determines whether a determination reference range exists for the measurement item X, that is, whether a numerical value that defines the determination reference range (a combination of an upper limit value and a lower limit value, an upper limit value only, or a lower limit value only) is set (step ST18). If it is determined that the determination reference range exists (YES in step ST18), the first margin determination unit 34A in the margin determination unit 34 uses the regression formula calculated in step ST17 to determine whether the measurement item X exceeds a margin (acceptable range), that is, whether the measurement value of the measurement item X is accepted (step ST19). Specifically, the first margin determination unit 34A determines whether at least one of an upper margin and a lower margin is exceeded (step ST19). The upper margin and the lower margin will be described below. In a case where the regression formula calculated in step ST17 is a linear regression formula, this regression formula can be expressed by the following formula (1).

y=a·x+b (1)

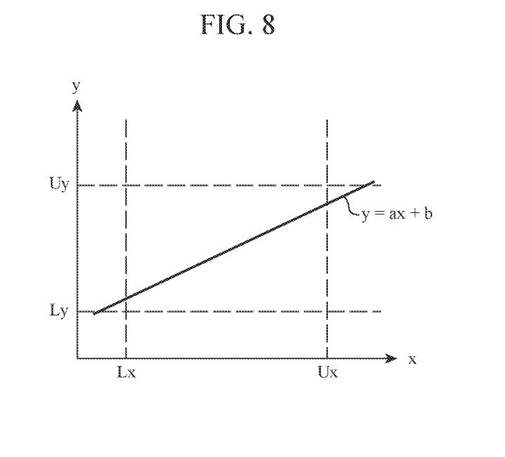

Here, y is an objective variable, x is an explanatory variable, a is a regression coefficient, and b is a constant. Furthermore, an upper limit value of the determination reference range of the measurement item X is denoted by Ux, the lower limit value of the determination reference range of the measurement item X is denoted by Lx. An upper limit reference value of the determination reference range of the inspection item Y is denoted by Uy, a lower limit reference value of the determination reference range of the measurement item X is denoted by Ly. On this condition, as exemplified in FIG. 8, if a prediction value (=a·Ux+b) of the regression formula where x=Ux is completely or substantially within the determination reference range between the upper limit reference value Uy and the lower limit reference value Ly, it is determined that the measurement item X does not exceed the upper margin. Otherwise, it is determined that the measurement item X exceeds the upper margin. On the other hand, if a prediction value (=a·Lx+b) of the regression formula where x=Lx is completely or substantially within the determination reference range between the upper limit reference value Uy and the lower limit reference value Ly, it is determined that the measurement item X does not exceed the lower margin. Otherwise, it is determined that the measurement item X exceeds the lower margin.

More specifically, in the case where a positive correlation is established between the series of measurement values of the measurement item X and the series of measurement values of the inspection item Y (where the regression coefficient a is positive), a condition for the measurement item X not to exceed the upper margin is, for example, that the following inequality (2A) holds, and a condition for the measurement item X not to exceed the lower margin is, for example, that the following inequality (3A) holds.

(a·Ux+b)−Uy≤δ₁ (2A)

Ly−(a·Lx+b)≤δ₂ (3A)

Here, δ₁ and δ₂ are positive threshold values of zero or around zero for margin determination. The inequality (2A) expresses a case where a difference value obtained by subtracting the upper limit value Uy from the prediction value (=a·Ux+b) where x=Ux is less than or equal to the threshold value δ₁. The inequality (3A) expresses a case where a difference value obtained by subtracting the prediction value (=a·Lx+b) where x=Lx from the lower limit value Ly is less than or equal to the threshold value δ₂.

In the case where a positive correlation is established (where the regression coefficient a is positive), a condition for the measurement item X to exceed the upper margin is, for example, that the following inequality (2B) holds, and a condition for the measurement item X to exceed the lower margin is, for example, that the following inequality (3B) holds.

(a·Ux+b)−Uy>δ₁ (2B)

Ly−(a·Lx+b)>δ₂ (3B)

The inequality (2B) expresses a case where a difference value obtained by subtracting the upper limit value Uy from the prediction value (=a·Ux+b) where x=Ux is larger than the threshold value δ₁. The inequality (3B) expresses a case where a difference value obtained by subtracting the prediction value (=a·Lx+b) where x=Lx from the lower limit value Ly is larger than the threshold value δ₂.

On the other hand, in the case where a negative correlation is established between the series of measurement values of the measurement item X and the series of measurement values of the inspection item Y (where the regression coefficient a is negative), a condition for the measurement item X not to exceed the upper margin is, for example, that the following inequality (4A) holds, and a condition for the measurement item X not to exceed the lower margin is, for example, that the following inequality (5A) holds.

Ly−(a·Ux+b)≤δ₃ (4A)

(a·Lx+b)−Uy≤δ₄ (5A)

Here, δ₃ and δ₄ are positive threshold values of zero or around zero for margin determination. The inequality (4A) expresses a case where a difference value obtained by subtracting the prediction value (=a·Ux+b) where x=Ux from the lower limit value Ly is less than or equal to the threshold value δ₃. The inequality (5A) expresses a case where a difference value obtained by subtracting the upper limit value Uy from the prediction value (=a·Lx+b) where x=Lx is less than or equal to the threshold value δ4.

In the case where a negative correlation is established (where the regression coefficient a is negative), a condition for the measurement item X to exceed the lower margin is, for example, that the following inequality (4B) holds, and a condition for the measurement item X to exceed the upper margin is, for example, that the following inequality (5B) holds.

Ly−(a·Ux+b)>δ₃ (4B)

(a·Lx+b)−Uy>δ₄ (5B)

The inequality (4B) expresses a case where a difference value obtained by subtracting the prediction value (=a·Ux+b) where x=Ux from the lower limit value Ly is larger than the threshold value δ₃. The inequality (5B) expresses a case where a difference value obtained by subtracting the upper limit value Uy from the prediction value (=a·Lx+b) where x=Lx is larger than the threshold value δ₄.

The threshold values δ₁, δ₂, δ₃, and δ₄ are stored in the condition memory 25. The condition setting unit 39 can store values input from the manual input device 42 via the I/F unit 40 as the threshold values δ₁, δ₂, δ₃, and δ₄ in the condition memory 25. Alternatively, as illustrated in the following mathematical formulas, values of coefficients ε₁ (0≤ε₁≤1), ε₂ (0≤ε₂≤1), ε₃ (0≤ε₃≤1), and ε₄ (0≤ε₄≤1) defining the threshold values δ₁ to δ₄ may be stored in the condition memory 25.

δ₁=(Uy−Ly)×ε₁

δ₂=(Uy−Ly)×ε₂

δ₃=(Uy−Ly)×ε₃

δ₄=(Uy−Ly)×ε₄

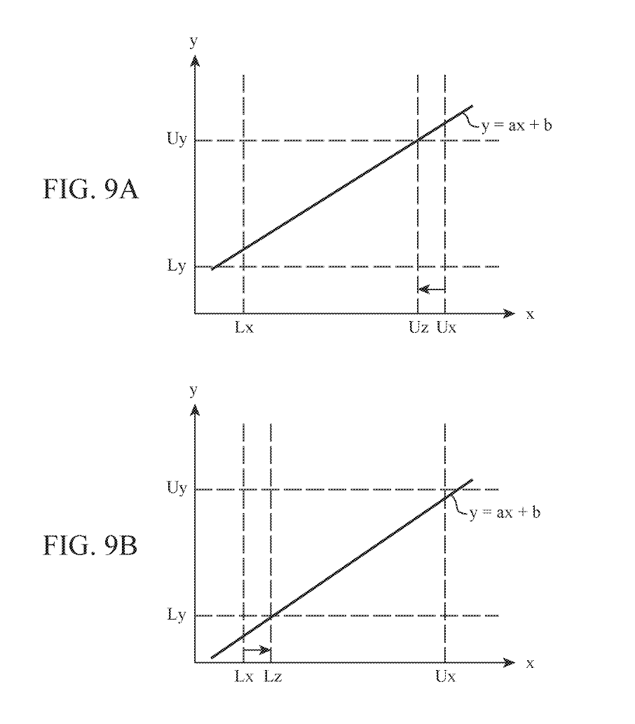

As described above, if a margin is exceeded (YES in step ST19), the tight reference value calculator 35A in the reference value calculator 35 newly calculates a tight reference value such that the determination reference range of the measurement item X is narrowed and that the measurement item X does not exceed the margin (step ST20). Specifically, for example, in the case where the above inequality (2B) holds and thus the measurement item X exceeds the upper margin, the tight reference value calculator 35A is only required to calculate a new upper limit reference value Uz satisfying the following inequality (6) as a tight reference value such that the determination reference range of the measurement item X is narrowed as illustrated in FIG. 9A.

0≤(a·Uz+b)−Uy≤δ₁ (6)

On the other hand, in the case where the above inequality (3B) holds and thus the measurement item X exceeds the lower margin, the tight reference value calculator 35A is only required to calculate a new lower limit reference value Lz satisfying the following inequality (7) as a tight reference value such that the determination reference range of the measurement item X is narrowed as illustrated in FIG. 9B.

0≤Ly−(a·Lz+b)≤δ₂ (7)

Meanwhile, if it is determined in step ST18 that no determination reference range exists (NO in step ST18), the tight reference value calculator 35A newly calculates a tight reference value such that the measurement item X does not exceed a margin (step ST21). A condition for determining that no determination reference range exists is, for example, a case where both the upper limit value Ux and the lower limit value Lx are set to zero (Ux=Lx=0).

The tight reference value calculator 35A outputs the tight reference value newly calculated in the above steps ST20 and ST21 to the data output controller 36.

If it is determined that the measurement item X does not exceed a margin in step ST19 (NO in step ST19), or if a tight reference value is calculated in step ST20, the data output controller 36 determines whether all pairs of the measurement items X and Y have been selected (step ST22).

If not all the pairs of the measurement items X and Y are selected (NO in step ST22), the data output controller 36 causes the item selector 32 to select an unselected combination (X, Y) (step ST13). Thereafter, steps ST14 to ST20 are executed. On the other hand, if all the pairs of the measurement items X and Y have been selected (YES in step ST22), the data output controller 36 determines whether all the upstream steps have been selected (step ST23). If it is determined that not all the upstream steps have been selected (NO in step ST23), the data output controller 36 causes the step selector 31 to select an unselected upstream step (step ST12). Thereafter, steps ST13 to ST22 are executed.

If it is determined that all the upstream steps have been selected in step ST23 (YES in step ST23), the data output controller 36 determines whether all the downstream steps have been selected (step ST24). If it is determined that not all the downstream steps have been selected (NO in step ST24), the data output controller 36 causes the step selector 31 to select an unselected downstream step (step ST11). Thereafter, steps ST12 to ST23 are executed.

If all the combinations of the upstream and downstream steps have been selected finally (YES in step ST24), the data output controller 36 terminates the above tight reference calculating processing.

The data output controller 36 supplies the pair of the measurement items X and Y and the tight reference value to the reference value setting unit 38. At this time, the reference value setting unit 38 can display an image representing the pair of the measurement items X and Y and the tight reference value on the display device 41 via the I/F unit 40. As a result, a user such as a product designer or an expert of inspection can evaluate validity of the tight reference value. Moreover, the reference value setting unit 38 can change or newly set a determination reference range in the reference value memory 24 in accordance with an instruction input to the manual input device 42 by the user who has evaluated the validity of the tight reference value. The reference value setting unit 38 can further supply the tight reference value to an inspection device to update or newly set a determination reference range.

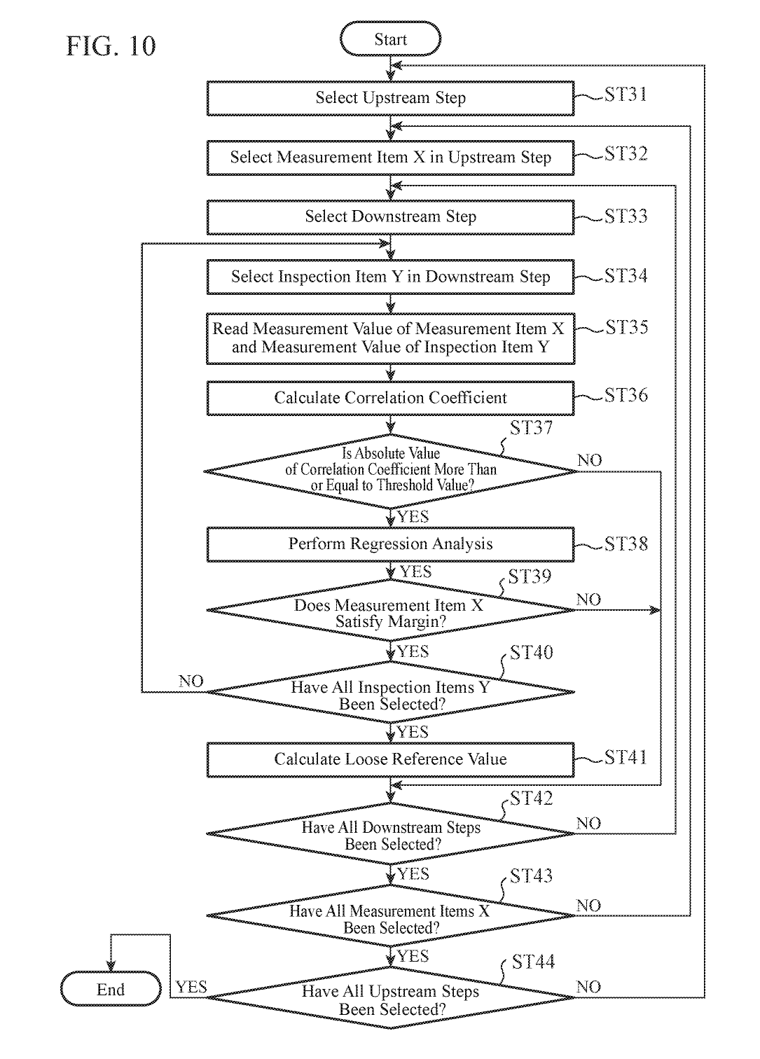

Next, referring to FIG. 10, a loose reference calculating processing will be described. FIG. 10 is a flowchart illustrating an exemplary procedure of loose reference calculating processing according to the first embodiment.

Referring to FIG. 10, the step selector 31 refers to the step order data (FIG. 4) stored in the process memory 23 and selects one of an inspection step and a fabrication step forming a part of the manufacturing process as an upstream step to be analyzed (step ST31). On the basis of a combination of an order identifier and a step ID in the step order data, the step selector 31 can select, for example, one of an inspection step and a fabrication step in an upstream stage with respect to the last inspection step, as the upstream step. Next, the item selector 32 selects one measurement item X of the selected upstream step (step ST32). Thereafter, the step selector 31 refers to the step order data stored in the process memory 23 and selects one inspection step in a downstream stage with respect to the selected upstream step, as a downstream step (step ST33). Next, the item selector 32 selects one inspection item Y in the selected downstream step (step ST34).

Next, like in step ST14, the regression analyzer 33 reads a series of measurement values x_{α}(i) of the measurement item X and a series of measurement values y_{β}(i) of the inspection item Y from the measurement value memory 22 (step ST35). Here, in a case where a plurality of measurement values exist for one measurement item in one step with respect to each fabricated piece, the regression analyzer 33 is only required to select and read the latest measurement value which has been determined to have a good quality from among the plurality of measurement values for the measurement item X in the upstream step. As for the inspection item Y in the downstream step, the regression analyzer 33 may select and read a measurement value at the time of the first entry into the manufacturing line (when the number of entries is “1”) from among such a plurality of measurement values.

After step ST35, the regression analyzer 33 calculates a correlation coefficient c₂ between the series of measurement values of the measurement item X and the series of measurement values of the inspection item Y (step ST36). The correlation coefficient c₂ can be calculated using, for example, a known cross-correlation function. Then, the regression analyzer 33 acquires a threshold value TH₂ for correlation determination from the condition memory 25 and determines whether an absolute value of the correlation coefficient c₂ is larger than or equal to the threshold value TH₂ (step ST37). If it is determined that the absolute value of the correlation coefficient c₂ is not larger than or equal to the threshold value TH₂ (NO in step ST37), the regression analyzer 33 shifts the processing to step ST42. In this regard, a statistical index other than the correlation coefficient may be used as long as the statistical index is a numerical value representing the degree of correlation between the series of measurement values of the measurement item X and the series of measurement values of the inspection item Y.

On the other hand, if it is determined that the absolute value of the correlation coefficient c₂ is larger than or equal to the threshold value TH₂ (YES in step ST37), the regression analyzer 33 determines that the degree of correlation between the series of measurement values of the measurement item X and the series of measurement values of the inspection item Y is high, and executes regression analysis using the measurement values x_{α}(i) of the measurement item X as values of the explanatory variable and using the measurement values y_{β}(i) of the inspection item Y as values of the objective variable, thereby to calculate a regression formula (step ST38).

Thereafter, the second margin determination unit 34B in the margin determination unit 34 determines whether the measurement item X satisfies a margin, that is, whether the measurement values of the measurement item X are accepted by using this regression formula (step ST39). Specifically, the second margin determination unit 34B determines whether both of an upper margin and a lower margin are satisfied simultaneously for the measurement item X (step ST39). The upper margin and the lower margin for loose reference calculating processing will be described below. First, a regression formula can be expressed by the following mathematical formula (1) like in the case of the tight reference calculating processing described above.

y=a·x+b (1)

In the case where a positive correlation is established between the series of measurement values of the measurement item X and the series of measurement values of the inspection item Y (where the regression coefficient a is positive), a condition for the measurement item X to satisfy the upper margin is, for example, that the following inequality (8) holds, and a condition for the measurement item X to satisfy the lower margin is, for example, that the following inequality (9) holds.

Uy−(a·Ux+b)>δ₁ (8)

(a·Lx+b)−Ly>δ₂ (9)

On the other hand, in the case where a negative correlation is established between the series of measurement values of the measurement item X and the series of measurement values of the inspection item Y (where the regression coefficient a is negative), a condition for the measurement item X to satisfy the lower margin is, for example, that the following inequality (10) holds, and a condition for the measurement item X to satisfy the upper margin is, for example, that the following inequality (11) holds.

(a·Ux+b)−Ly>δ₃ (10)

Uy−(a·Lx+b)>δ₄ (11)

Values δ₁, δ₂, δ₃, and δ₄ are the same as the threshold values used in the tight reference calculating processing described above.

Next, the second margin determination unit 34B determines whether all the inspection items Y have been selected (step ST40). If it is determined that not all the inspection items Y have been selected (NO in step ST40), the second margin determination unit 34B shifts the processing to step ST34. Thereafter, an unselected inspection item Y is selected (step ST34), and steps ST35 to ST39 are executed.

If the measurement item X satisfies the margin for all the inspection items Y in the downstream step (YES in step ST39 and YES in step ST40), the loose reference value calculator 35B in the reference value calculator 35 newly calculates a loose reference value such that the determination reference range of the measurement item X is expanded (step ST41). Specifically, for example, the loose reference value calculator 35B can calculate a new upper limit reference value Uk as a loose reference value from the following mathematical formula (12).

Uk=MIN {x|y=a·x+b,y={Uy,Ly}, and x>Ux} (12)

Brackets { } on the right side of the above mathematical formula (12) represent a set {x} of x coordinate values (>Ux) larger than the upper limit value Ux of the determination reference range of the measurement item X out of a set of x coordinate values of intersections of the regression line (y=a·x+b) and y={Uy} and x coordinate values of intersections of the regression line and a linear line y={Ly}. Here, {Uy} means a set of upper limit values Uy of determination reference ranges of all inspection items Y selected in step ST34 for a specific measurement item X, and {Ly} means a set of lower limit values Ly of determination reference ranges of all inspection items Y selected in step ST34 for the specific measurement item X. The loose reference value Uk on the left side of the mathematical formula (12) is the minimum value in the set {x} of the x coordinate values on the right side of the above mathematical formula (12).

The loose reference value calculator 35B can further calculate a new lower limit reference value Lk as a loose reference value from the following mathematical formula (13).

Lk=MAX {x|y=a·x+b,y={Uy,Ly}, and x<Lx} (13)

Brackets { } on the right side of the above mathematical formula (13) represent a set {x} of x coordinate values (<Lx) smaller than the lower limit value Lx of the determination reference range of the measurement item X out of a set of x coordinate values of intersections of the regression line (y=a·x+b) and y={Uy} and x coordinate values of intersections of the regression line and y={Ly}. Here, {Uy} means a set of upper limit values Uy of determination reference ranges of all inspection items Y selected in step ST34 for a specific measurement item X, and {Ly} means a set of lower limit values Ly of determination reference ranges of all inspection items Y selected in step ST34 for the specific measurement item X. The loose reference value Lk on the left side of the mathematical formula (13) is the maximum value in the set {x} of the x coordinate values on the right side of the above mathematical formula (13).

If it is determined that the measurement item X does not satisfy a margin in step ST39 (NO in step ST39), or if a loose reference value is calculated in step ST41, the data output controller 36 determines whether all the downstream steps have been selected (step ST42). If it is determined that not all the downstream steps have been selected (NO in step ST42), the data output controller 36 causes the step selector 31 to select an unselected downstream step (step ST33). Thereafter, step ST34 is executed.

If it is determined that all the downstream steps have been selected in step ST42 (YES in step ST42), the data output controller 36 determines whether all the measurement items X have been selected (step ST43). If it is determined that not all the measurement items X have been selected (NO in step ST43), the data output controller 36 causes the item selector 32 to select an unselected measurement item X (step ST32). Thereafter, step ST33 is executed.

If it is determined that all the measurement items X have been selected in step ST43 (YES in step ST43), the data output controller 36 determines whether all the upstream steps have been selected (step ST44). If it is determined that not all the upstream steps have been selected (NO in step ST44), the data output controller 36 causes the step selector 31 to select an unselected upstream step (step ST31). Thereafter, step ST32 is executed.

If all the combinations of the upstream and downstream steps have been selected finally (YES in step ST44), the data output controller 36 terminates the above loose reference calculating processing.

The data output controller 36 supplies the pair of the measurement items X and Y and the loose reference value to the reference value setting unit 38. At this time, the reference value setting unit 38 can display an image representing the pair of the measurement items X and Y and the loose reference value on the display device 41 via the I/F unit 40. As a result, a user such as a product designer or an expert of inspection can evaluate validity of the loose reference value. Moreover, the reference value setting unit 38 can change or newly set a determination reference range in the reference value memory 24 in accordance with an instruction input to the manual input device 42 by the user who has evaluated the validity of the loose reference value. The reference value setting unit 38 can further supply the loose reference value to an inspection device to update or newly set a determination reference range.

A hardware configuration of the quality control apparatus 20 described above can be implemented by an information-processing device having a computer configuration incorporating a central processing unit (CPU) such as a workstation or a mainframe. Alternatively, a hardware configuration of the quality control apparatus 20 may be implemented by an information-processing device having an integrated circuit such as a digital signal processor (DSP), an application specific integrated circuit (ASIC), or an field-programmable gate array (FPGA).

All or a part of the measurement value receiver 21, the measurement value memory 22, the process memory 23, the reference value memory 24, and the condition memory 25 may be configured using a function of a data management program such as a relational database management system (RDBMS) or may be configured using computer systems or information-processing devices connected to each other via a communication network.

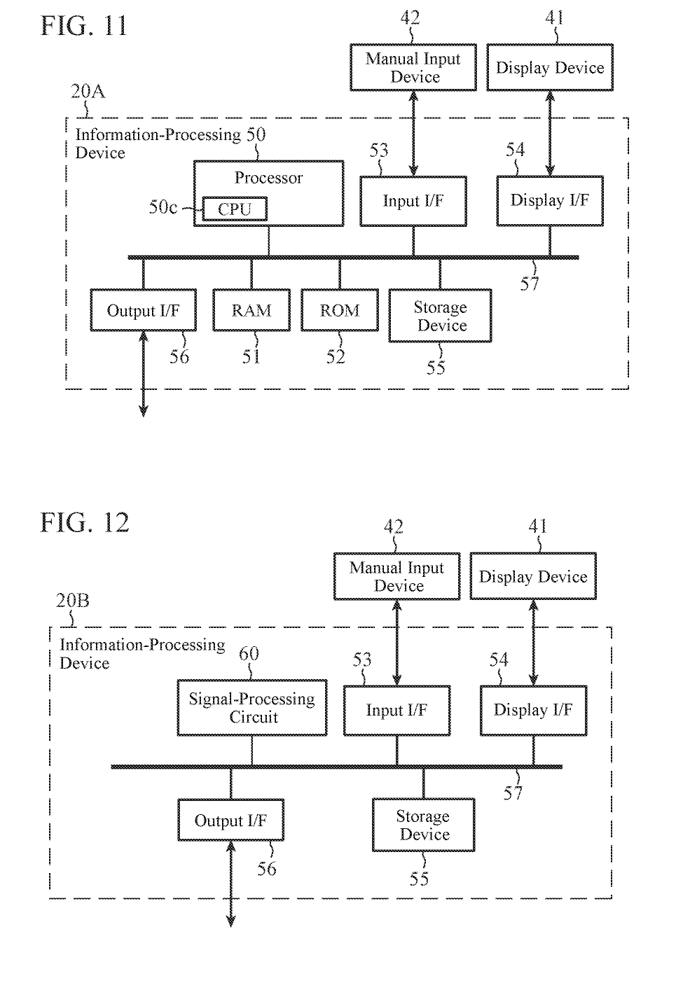

FIG. 11 is a block diagram illustrating a schematic configuration of an information-processing device 20A as an exemplary hardware configuration of the quality control apparatus 20. The information-processing device 20A includes a processor 50 including a CPU 50c, a random access memory (RAM) 51, a read only memory (ROM) 52, an input interface (input I/F) 53, a display interface (display I/F) 54, a storage device 55, and an output interface (output I/F) 56. The processor 50, the RAM 51, the ROM 52, the input I/F 53, the display I/F 54, the storage device 55, and the output I/F 56 are mutually connected via a signal path 57 such as a bus circuit. The processor 50 reads a quality control program, which is a computer program, from the ROM 52 and operates according to the quality control program, thereby enabling implementation of the functions of the quality control apparatus 20. Each of the input I/F 53, the display I/F 54, and the output I/F 56 is a circuit having a function of transmitting and receiving signals to and from an external hardware device.

As the storage device 55, it is possible to use for example a recording medium such as a hard disk drive (HDD) or a solid state drive (SSD). Alternatively, a detachable recording medium such as a flash memory may be used as the storage device 55.

In a case where the quality control apparatus 20 of FIG. 2 is configured using the information-processing device 20A of FIG. 11, the components 21, 31 to 36, 38, and 39 of the quality control apparatus 20 can be implemented by the processor 50 illustrated in FIG. 11 and a quality control program. The components 22 to 25 of the quality control apparatus 20 can be implemented by the storage device 55 illustrated in FIG. 11. Meanwhile, the function of supplying the output data group RV of the reference value setting unit 38 to the inspection devices 11₁ to 11_{Q} can be implemented by the output I/F 56 illustrated in FIG. 11. Furthermore, the I/F unit 40 of FIG. 2 can be implemented by the input I/F 53 and the display I/F 54 illustrated in FIG. 11.

Next, FIG. 12 is a block diagram illustrating a schematic configuration of an information-processing device 20B as another exemplary hardware configuration of the quality control apparatus 20. The information-processing device 20B includes a signal processing circuit 60 formed by an LSI such as a DSP, an ASIC, or an FPGA, an input I/F 53, a display I/F 54, a storage device 55, and an output I/F 56. The signal processing circuit 60, the input I/F 53, the display I/F 54, the storage device 55, and the output I/F 56 are mutually connected via a signal path 57. In a case where the quality control apparatus 20 of FIG. 2 is configured using the information-processing device 20B of FIG. 12, the components 21, 31 to 36, 38, and 39 of the quality control apparatus 20 can be implemented by the signal processing circuit 60 illustrated in FIG. 12. The components 22 to 25 of the quality control apparatus 20 can be implemented by the storage device 55 illustrated in FIG. 12. Meanwhile, the function of supplying the output data group RV of the reference value setting unit 38 to the inspection devices 11₁ to 11_{Q} can be implemented by the output I/F 56 illustrated in FIG. 12. Furthermore, the I/F unit 40 of FIG. 2 can be implemented by the input I/F 53 and the display I/F 54 illustrated in FIG. 12.

As described above, the quality control apparatus 20 according to the present embodiment enables appropriately adjusting the determination reference range in a step in the upstream stage in accordance with the condition of the downstream step, and thus it is possible to improve the yield. Moreover, since the tight reference calculating processing and the loose reference calculating processing according to the present embodiment are executed on combinations of steps forming the manufacturing process, it is possible to optimize the determination references for the entire plurality of steps in the manufacturing process.

### Second Embodiment

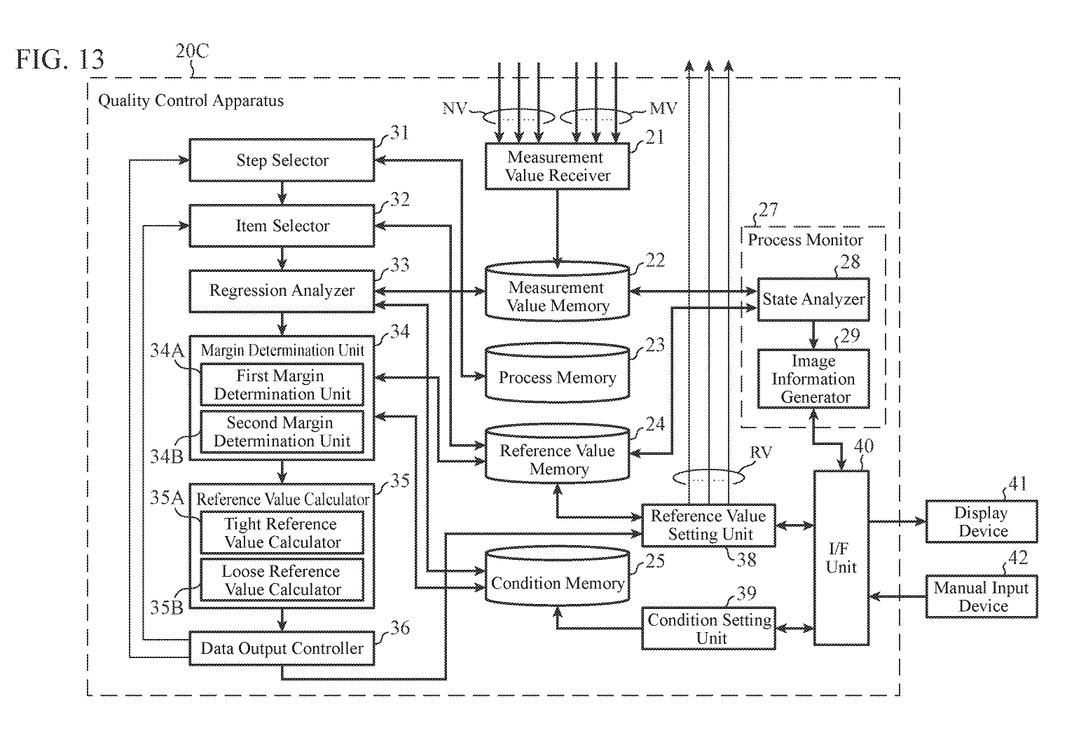

Next, a manufacturing system according to a second embodiment of the present invention will be described. FIG. 13 is a block diagram illustrating a schematic configuration of a quality control apparatus 20C in a manufacturing system of the second embodiment. A configuration of the manufacturing system of the second embodiment is the same as that of the manufacturing system 1 of the first embodiment except that the quality control apparatus 20C of FIG. 13 is included instead of the quality control apparatus 20 of FIG. 2. The configuration of the quality control apparatus 20C according to the present embodiment is the same as that of the quality control apparatus 20 of the first embodiment except that a process monitor 27 is included.

As illustrated in FIG. 13, the process monitor 27 includes a state analyzer 28 and an image information generator 29. The state analyzer 28 monitors whether a new determination reference value (one of a tight reference value and a loose reference value, or both a tight reference value and a loose reference value) is calculated by the reference value calculator 35. When the reference value calculator 35 detects that a new determination reference value has been calculated, the state analyzer 28 is capable of predicting the states of quality (for example, state of being a nondefective piece or a defective piece) of fabricated pieces in upstream steps when the new determination reference value is applied, and further predicting the states of quality (for example, the state of being a nondefective piece and/or a defective piece) of the fabricated pieces in downstream steps in downstream stages with respect to the upstream step. The image information generator 29 is capable of generating image information (for example, statistical data indicating the number of nondefective pieces or defective pieces) indicating the states of quality of the fabricated pieces in the upstream step and the downstream step, predicted by the state analyzer 28, supplying the generated image information to a display device 41 via an I/F unit 40, and thereby displaying the image information on the display device 41. As a result, a user such as a product designer or an expert of inspection can correctly evaluate validity of the new determination reference value on the basis of the image information.

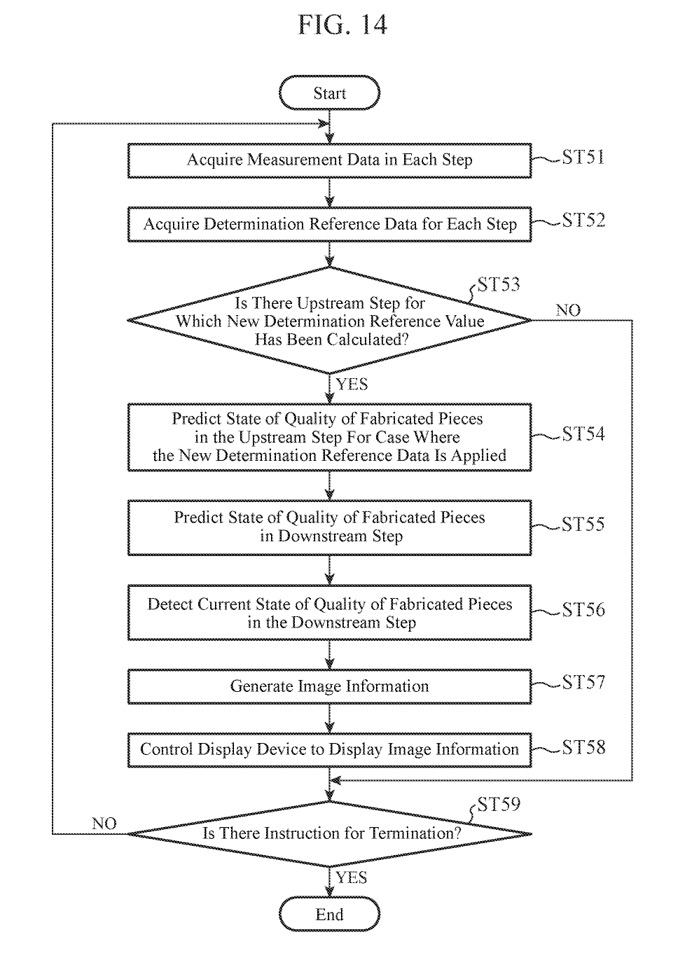

Hereinafter, operations of the process monitor 27 will be described with reference to FIG. 14. FIG. 14 is a flowchart schematically illustrating an exemplary procedure of process monitoring processing according to the second embodiment.

Referring to FIG. 14, first, the state analyzer 28 acquires measurement data in each of steps from a measurement value memory 22 (step ST51), and acquires determination reference data for each of the steps from the reference value memory 24 (step ST52). Then, the state analyzer 28 determines whether there is an upstream step for which a new determination reference value (one of a tight reference value and a loose reference value, or both of a tight reference value and a loose reference value), which is different from a determination reference value (an upper limit value or a lower limit value) included in the acquired determination reference data, has been calculated (step ST53). If there is no upstream step for which a new determination reference value has been calculated does not occur (NO in step ST53), the processing proceeds to step ST58.

On the other hand, if there is an upstream step for which a new determination reference value has been calculated (YES in step ST53), the state analyzer 28 uses measurement data of the upstream step acquired in step ST51 to predict the states of quality of fabricated pieces in the upstream step for a case where the new determination reference value is applied to the upstream step (step ST54). The state analyzer 28 further uses measurement data in a downstream step acquired in step ST51 to predict the states of quality of the fabricated pieces in a downstream step (step ST55), and further detects the current states of quality of the fabricated pieces in the downstream step (step ST56).

The image information generator 29 generates image information indicating the quality state predicted and detected in steps ST54 to ST56 (step ST57) and controls the display device 41 to display the image information (step ST58). Thereafter, if there is an end instruction (YES in step ST58), the process monitor 27 ends the process monitoring processing. If there is no end instruction (NO in step ST58), the process monitor 27 proceeds the processing after step ST51.

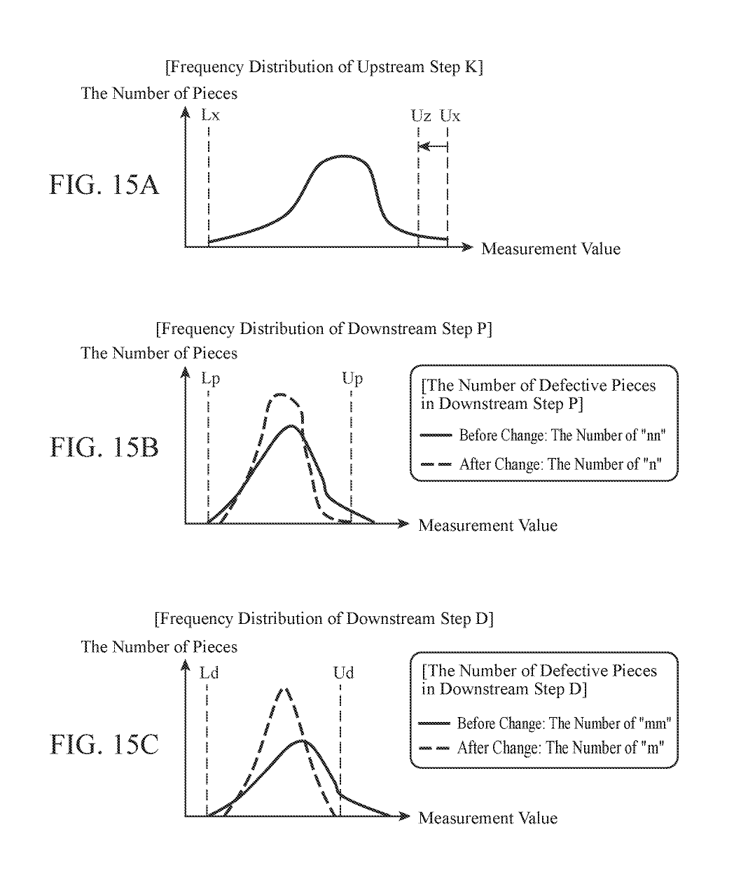

FIGS. 15A to 15C are diagrams illustrating exemplary image information when a tight reference value Uz is newly calculated for a certain measurement item in an upstream step K. FIG. 15A is a graph schematically illustrating a current frequency distribution (distribution of the number of pieces) of the defective pieces. FIG. 15B is a graph schematically illustrating a frequency distribution (distribution of the number of pieces) of defective pieces which are predicted to be generated in a downstream step P in accordance with change of a determination reference value in the upstream step K (application of the tight reference value Uz). Moreover, FIG. 15C is a graph schematically illustrating a frequency distribution (distribution of the number of pieces) of defective pieces which are predicted to be generated in a downstream step D in accordance with change of a determination reference value in the upstream step K. In FIGS. 15B and 15C, the current frequency distribution curve before the change of the determination reference value is represented by a solid line, and a frequency distribution curve predicted after the change of the determination reference value is represented by a broken line. Furthermore, in FIGS. 15B and 15C, the calculated number of defective pieces is also displayed. As illustrated in FIG. 15A, when the tight reference value Uz is applied to the upstream step K, a fabricated piece, which has been passed as a nondefective piece so far in the upstream step K, turns into a defective piece after application of the tight reference value Uz and is not allowed to flow to the downstream steps P and D. Therefore, it is predicted that the number of defective pieces in the upstream step K increases and that the number of pieces flowing to downstream steps and the number of defective pieces decrease.

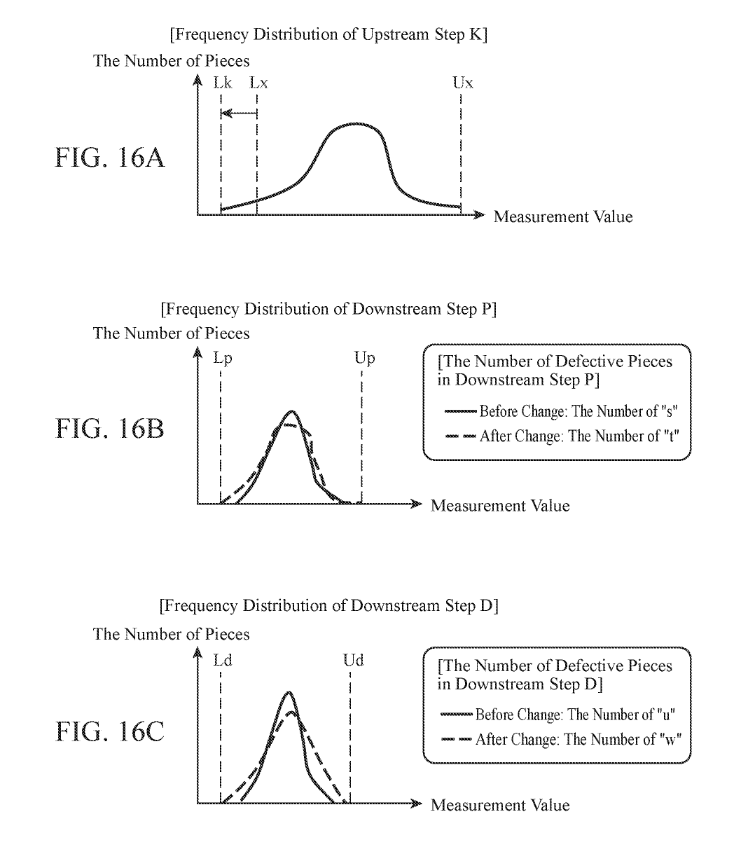

On the other hand, FIGS. 16A to 16C are diagrams illustrating exemplary image information when a loose reference value Lk is newly calculated for a certain measurement item in the upstream step K. FIG. 16A is a graph schematically illustrating a current frequency distribution (distribution of the number of pieces) of the defective pieces. FIG. 16B is a graph schematically illustrating a frequency distribution (distribution of the number of pieces) of defective pieces which are predicted to be generated in a downstream step P in accordance with change of a determination reference value in the upstream step K (application of the loose reference value Lk). Moreover, FIG. 16C is a graph schematically illustrating a frequency distribution (distribution of the number of pieces) of defective pieces which are predicted to be generated in a downstream step D in accordance with change of a determination reference value in the upstream step K. In FIGS. 16B and 16C, the current frequency distribution curve before the change of the determination reference value is represented by a solid line, and a frequency distribution curve predicted after the change of the determination reference value is represented by a broken line. Furthermore, in FIGS. 16B and 16C, the calculated number of defective pieces is also displayed. As illustrated in FIG. 16A, when the loose reference value Lk is applied to the upstream step K, a fabricated piece, which has been determined as a defective piece in the upstream step K and has not been allow to pass to the downstream steps P and D, is predicted to turn into a nondefective piece and to flow to the downstream steps P and D after application of the loose reference value Lk.

As described above, in the second embodiment, the process monitor 27 can detect whether a new determination reference value has been calculated for an upstream step in an upstream stage. When the new determination reference value is applied in the upstream step in the upstream stage, the process monitor 27 is capable of predicting the states of quality of fabricated pieces in both the upstream step in the upstream stage and a downstream step in a downstream stage. A user such as a product designer or an expert of inspection can accurately evaluate the effect of applying the new determination reference value on the basis of the prediction result.

The image information generator 29 may generate image information such as a scatter diagram and display the image information on the display device 41 without being limited to the frequency distributions and the number of defective pieces illustrated in FIGS. 15A to 15C and 16A to 16C. Moreover, the hardware configuration of the quality control apparatus 20C of the second embodiment can be implemented by the information-processing device 20B or 20C like the quality control apparatus 20 of the first embodiment can be.

Although the various embodiments according to the present invention have been described with reference to the drawings, these embodiments are examples of the present invention, and thus, various embodiments other than the above-described embodiments can be adopted. It is to be noted that, within the scope of the present invention, an arbitrary combination of the components 1 and 2 of the above-described embodiments, modification of any component of the above-described embodiments, or omission of any component of the above-described embodiments can be made.

### INDUSTRIAL APPLICABILITY

The quality control apparatus and the manufacturing system according to the present invention are capable of adjusting a determination reference range in an inspection step of a manufacturing process and thus are suitable for use in, for example, quality inspection of an intermediate product generated in the step of the manufacturing process, or of a final product.

### REFERENCE SIGNS LIST

1: Manufacturing system; 10₁ to 10_{R}: Fabrication devices; 11₁ to 11_{Q}: Inspection devices; 20, 20C: quality control apparatuses; 20A, 20B: Information-processing devices; 21: Measurement value receiver; 22: measurement value memory; 23: Process memory; 24: Reference value memory; 25: Condition memory; 27: Process monitor; 28: State analyzer; 29: Image information generator; 31: Step selector; 32: Item selector; 33: Regression analyzer; 34: Margin determination unit; 34A: First margin determination unit; 34B: Second margin determination unit; 35: Reference value calculator; 35A: Tight reference value calculator; 35B: Loose reference value calculator; 36: Data output controller; 38: Reference value setting unit; 39: Condition setting unit; 40: Interface unit (I/F unit); 41: Display device; 42: Manual input device; 50: Processor; 50c: CPU; 51: RAM; 52: ROM; 53: Input interface (input I/F); 54: Display interface (display I/F); 55: Storage device; 56: Output interface (output I/F); and 60: Signal processing circuit.

1. A quality control apparatus, comprising:
a measurement value receiver to acquire a series of measurement values from an upstream step which is one of an inspection step and a fabrication step among a plurality of steps forming a manufacturing process, and to acquire a series of comparative measurement values corresponding to the series of the measurement values, from a downstream step which is another inspection step among the plurality of steps in downstream stages with respect to the upstream step;
a regression analyzer to execute a regression analysis using the measurement values as values of an explanatory variable and using the comparative measurement values as values of an objective variable, thereby to calculate a regression formula;
a margin determination unit to calculate a prediction value by assigning a determination reference value defining a determination reference range for quality determination in the upstream step, to the explanatory variable of the regression formula, and to compare the prediction value with a comparative determination reference range for quality determination in the downstream step to determine whether the measurement values are accepted; and
a reference value calculator to calculate a new determination reference value for replacement of the determination reference value in accordance with the determination result of the margin determination unit.

2. The quality control apparatus according to claim 1, wherein, when the measurement values are determined not to be accepted, the reference value calculator calculates the new determination reference value in a manner that narrows the determination reference range.

3. The quality control apparatus according to claim 2, wherein:
the determination reference value is an upper limit value of the determination reference range; and
the margin determination unit determines that the measurement values are not accepted when a first difference value obtained by subtracting an upper limit value of the comparative determination reference range from the prediction value is larger than a first threshold value or when a second difference value obtained by subtracting the prediction value from a lower limit value of the comparative determination reference range is larger than a second threshold value.

4. The quality control apparatus according to claim 2, wherein:
the determination reference value is a lower limit value of the determination reference range; and
the margin determination unit determines that the measurement values are not accepted when a third difference value obtained by subtracting the prediction value from a lower limit value of the comparative determination reference range is larger than a third threshold value or when a fourth difference value obtained by subtracting an upper limit value of the comparative determination reference range from the prediction value is larger than a fourth threshold value.

5. The quality control apparatus according to claim 1, wherein, when the measurement values are determined to be accepted, the reference value calculator calculates the new determination reference value in a manner that expands the determination reference range.

6. The quality control apparatus according to claim 5, wherein:
the determination reference value is an upper limit value of the determination reference range; and
the margin determination unit determines that the measurement values are accepted when a first difference value obtained by subtracting the prediction value from an upper limit value of the comparative determination reference range is larger than a first threshold value or when a second difference value obtained by subtracting a lower limit value of the comparative determination reference range from the prediction value is larger than a second threshold value.

7. The quality control apparatus according to claim 5, wherein:
the determination reference value is a lower limit value of the determination reference range; and
the margin determination unit determines that the measurement values are accepted when a third difference value obtained by subtracting a lower limit value of the comparative determination reference range from the prediction value is larger than a third threshold value or when a fourth difference value obtained by subtracting the prediction value from an upper limit value of the comparative determination reference range is larger than a fourth threshold value.

8. The quality control apparatus according to claim 1, wherein the regression analyzer calculates a degree of correlation between the series of measurement values and the series of comparative measurement values, and executes the regression analysis when the degree of correlation is larger than or equal to a predetermined threshold value.

9. The quality control apparatus according to claim 1, further comprising a state analyzer to predict states of quality of fabricated pieces in the upstream step when the new determination reference value is applied.

10. The quality control apparatus according to claim 9, further comprising an image information generator, wherein:
the state analyzer predicts states of quality of the fabricated pieces in the downstream step on a basis of the predicted states of quality of the fabricated pieces in the upstream step; and
the image information generator generates image information indicating the predicted states of quality of the fabricated pieces in the downstream step and controls a display device to display the image information.

11. A quality control method to be executed in a quality control apparatus for controlling quality in a plurality of steps forming a manufacturing process, the quality control method comprising:
acquiring a series of measurement values from an upstream step which is one of an inspection step and a fabrication step among a plurality of steps forming a manufacturing process;
acquiring a series of comparative measurement values corresponding to the series of the measurement values, from a downstream step which is another inspection step among the plurality of steps in downstream stages with respect to the upstream step;
executing a regression analysis using the measurement values as values of an explanatory variable and using the comparative measurement values as values of an objective variable thereby to calculate a regression formula;
calculating a prediction value by assigning a determination reference value defining a determination reference range for quality determination in the upstream step, to the explanatory variable of the regression formula;
comparing the prediction value with a comparative determination reference range for quality determination in the downstream step to determine whether the measurement values are accepted; and
calculating a new determination reference value for replacement of the determination reference value in accordance with the determination result.

12. The quality control method according to claim 11, wherein, when the measurement values are determined not to be accepted, the new determination reference value is calculated in a manner that narrows the determination reference range.

13. The quality control method according to claim 11, wherein, when the measurement values are determined to be accepted, the new determination reference value is calculated in a manner that expands the determination reference range.

14. The quality control method according to claim 11, further comprising predicting states of quality of fabricated pieces in the upstream step when the new determination reference value is applied.

15. The quality control method according to claim 14, further comprising:
predicting states of quality of the fabricated pieces in the downstream step on a basis of the predicted states of quality of the fabricated pieces in the upstream step;
generating image information indicating the predicted states of quality of the fabricated pieces in the downstream step; and
controlling a display device to display the image information.

16. A quality control apparatus for controlling quality in a plurality of steps forming a manufacturing process, the quality control apparatus comprising:
a processor; and
a memory coupled to the processor, and including a quality control program stored thereon which, when executed by the processor, causes the processor to execute the operations of:
acquiring a series of measurement values from a upstream step which is one of an inspection step and a fabrication step among a plurality of steps forming a manufacturing process;
acquiring a series of comparative measurement values corresponding to the series of the measurement values from a downstream step which is another inspection step among the plurality of steps in downstream stages with respect to the upstream step;
executing a regression analysis using the measurement values as values of an explanatory variable and using the comparative measurement values as values of an objective variable thereby to calculate a regression formula;
calculating a prediction value by assigning a determination reference value defining a determination reference range for quality determination in the upstream step, to the explanatory variable of the regression formula;
comparing the prediction value with a comparative determination reference range for quality determination in the downstream step to determine whether the measurement values are accepted; and
calculating a new determination reference value for replacement of the determination reference value in accordance with the determination result.

17. The quality control apparatus according to claim 16, wherein, when the measurement values are determined not to be accepted, the new determination reference value is calculated in a manner that narrows the determination reference range.

18. The quality control apparatus according to claim 16, wherein, when the measurement values are determined to be accepted, the new determination reference value is calculated in a manner that expands the determination reference range.

19. The quality control apparatus according to claim 16, the quality control program which causes the processor to further execute the operation of predicting states of quality of fabricated pieces in the upstream step when the new determination reference value is applied.

20. The quality control apparatus according to claim 19, the quality control program which causes the processor to further execute the operations of:
predicting states of quality of the fabricated pieces in the downstream step on a basis of the predicted states of quality of the fabricated pieces in the upstream step;
generating image information indicating the predicted states of quality of the fabricated pieces in the downstream step; and
controlling a display device to display the image information.
